(19) United States
(12) Patent Application Publication
(10) Pub. No.: US 2010/0302255 A1
(43) Pub. Date: Dec. 2, 2010

(54) METHOD AND SYSTEM FOR GENERATING A CONTEXTUAL SEGMENTATION CHALLENGE FOR AN AUTOMATED AGENT

(75) Inventors: Timothy J. Brown, Salt Lake City, UT (US); Anthony R. Koziol, Gainesville, FL (US); Jason D. Koziol, Naperville, IL (US)

Correspondence Address: Law Office of Daniel W. Roberts, 904 Topaz Street, Superior, CO, 80027, US

(73) Assignee: Dynamic Representation Systems, LLC-Part VII, Naperville, IL (US)

(21) Appl. No.: 12/786,711

(22) Filed: May 25, 2010

Related U.S. Application Data
(60) Provisional application No. 61/180,983, filed on May 26, 2009.

(51) Int. Cl. G06T 15/70

(52) U.S. Cl. 345/473

(57) ABSTRACT

Provided is a system and method for generating a contextual segmentation challenge that poses an identification challenge. The method including obtaining at least one ad element and obtaining a test element. The ad element and the test element then combined to provide a composite image. At least one noise characteristic is then applied to the composite image. The composite image is then animated as a plurality of views as a contextual segmentation challenge. A system for performing the method is also provided.

### CROSS REFERENCE TO RELATED APPLICATIONS

This application claims the benefit under 35 U.S.C. §119(e) of U.S. Provisional Application No. 61/180,983 filed May 26, 2009, the disclosure of which is incorporated herein by reference.

### FIELD OF THE INVENTION

The present invention relates generally to data security and more particularly to methods and systems for generating a contextual segmentation challenge that poses an identification challenge.

### BACKGROUND

Sensitive data, such as for example, email addresses, phone numbers, residence addresses, usernames, user passwords, social security numbers, credit card numbers and/or other personal information are routinely stored on computer systems. Individuals often use personal computers to store bank records and personal address listings. Web servers frequently store personal data associated with different groups, such as clients and customers. In many cases, such computers are coupled to the Internet or other network which is accessible to other users and permits data exchange between different computers and users of the network and systems.

Connectivity to the Internet or other network often exposes computer systems to malicious autonomous software applications or automated agents. Automated agents are typically generated by autonomous software applications that operate to “appear” as an agent for a user or a program. Real and/or virtual machines are used to generate automated agents that simulate human user activity and/or behavior to search for and gain illegal access to computer systems connected to the Internet or other network, retrieve data from the computer systems and generate databases of culled data for unauthorized use by illegitimate users.

Automated agents typically consist of one or more sequenced operations. The sequence of operations can be executed by a real or virtual machine processor to enact the combined intent of one or more developers and/or deployers of the sequence of operations. The size of the sequence of operations associated with an automated agent can range from a single machine coded instruction to a distributed operating system running simultaneously on multiple virtual processing units. An automated agent may consist of singular agents, independent agents, an integrated system of agents and agents composed of sub-agents where the sub-agents themselves are individual automated agents. Examples of such automated agents include, but are not limited to, viruses, Trojans, worms, bots, spiders, crawlers and keyloggers.

The increased use of computer systems that are communicatively coupled to the Internet or other networks to store and manipulate different forms of sensitive data has generated a need to format sensitive data into a form that is recognizable to a human user while posing an identification challenge to an automated agent. Storing and/or transmitting sensitive data in such a format enables human users to access the data for legitimate reasons while making it a challenge for automated agents to access the data for illegitimate reasons.

It is therefore desirable to implement systems and methodologies to determine whether a client accessing a system is a human user or not. Such systems may be known by different names, such as Human Only Perceptible (“HOP”), Human Interactive Proof (“HIP”) and/or Completely Automated Public Turing Test to Tell Computers and Humans Apart (“CAPTCHA”).

As the use of networks such as the Internet has grown commonplace, so too has the opportunity for commercialization and business. As with newspapers, magazines, television and radio, advertising has taken root as a common method of generating business for the originator of the ad, and hosting ads is a common method of profit generation for many websites.

With respect to the issue of controlling access to a website, the use of ads themselves as the basis for a CAPTCHA system is evolving. An example is 2009/0210937 by Kraft et al., entitled Captcha Advertising. In this application a user is presented with an advertising video clip which communicates the complete authenticating reference pass phrase to the user, either explicitly or associatively. For example, the application teaches that a can of Coca-Cola may be presented and the user is then required to input the pass phrase “Coca-cola”. As the user is familiar with the ad or at least ads of the presented type, it is expected that the user will quickly recognize the ad and the pass phrase solution. Kraft further teaches that the use of a single video advertising video clip which incorporates the pass phrase expressly or implicitly and without distortion permits easier recognition compared to other CAPTCHA systems wherein the pass phrase is heavily distorted. Moreover, Kraft not only ties the pass phrase directly to the advertisement, but is also apparently choosing to employ no further methods to thwart automated determination of the pass phrase.

Another example is US 2009/02024819 by Parker entitled Advertisement-Based Human Interactive Proof (HIP). In this application the HIP is entirely ad based as in Kraft. Specifically, Parker expressly states “the user will be asked to identify a product, service, company, slogan, or the like contained in the advertisement as the solution to the HIP challenge.” Here again, the users' familiarity with the ad, ad content or similar ads will enhance the users' ability to quickly spot and recognize the service, feature, company, slogan or other ad element that is the solution to the HIP challenge. As in Kraft, Parker teaches that there is no intentional distortion or additional characteristics added of security.

Moreover for both of these applications, the context of the solution is tied directly to the context of the advertisement. As the solution is related directly to the advertisement the number of possible solutions is somewhat constrained. Indeed a database could be established to recognize aspects (e.g., geometric shape and/or patterns, colors, key phrases, etc. . . . ) of known advertisements which could aid an automated system in exploring solution options.

Further, these applications appear most suited to gate-keeper implantations where the purpose of the CAPTCHA or HIP is to control access to content. More specifically, neither application is intended to provide a user with user desired content or information. In other words these applications omit all opportunity to provide a user with user desired information that is not contextually related to the advertisement. And again, the ad and challenge are apparently rendered entirely in the clear with no distortion or other proactive measure to frustrate an automated agent. In addition, both Kraft and Parker require the user to respond, such that both systems are only viable for HIP or CAPTCHA, but not for HOP which does not require a user's response.

In some prior art systems, static images of sensitive data are represented in a format that includes one or more different noise components. For example, noise components in the form of various types of deformations and/or distortions are introduced into the static image representation of the sensitive data. For example, in a CAPTCHA representation of data, noise is deliberately and/or strategically integrated into the static image representation of the sensitive data in an attempt to protect the sensitive data from automated agents that may gain unauthorized access to the data.

Often the noise element is provided in a systematic way that can be determined by review and analysis. Once understood and/or otherwise identified the noise element can be removed and optical character recognition or other methodology may be employed to understand the sensitive data.

In neither of the examples of Kraft or Parker is the issue and potential benefit of additive noise suggested. Indeed the focus on advertising as both the message and the challenge for both teaches that the CAPTCHA or HIP is presented free and clear without noise or other distortion so that the advertising is in no way compromised. Moreover security appears secondary to advertising.

Hence there is a need for a method and system for generating a contextual segmentation challenge that poses an identification challenge.

### SUMMARY

This invention provides a method and system for generating a contextual segmentation challenge that poses an identification challenge.

In particular, and by way of example only, according to one embodiment of the present invention, a method of generating a contextual segmentation challenge for an automated agent, the method including: obtaining at least one ad element; obtaining a test element; combining the ad element and the test element to provide a composite image; adding at least one noise characteristic to the composite image; and animating the composite image as a plurality of views as a contextual segmentation challenge.

In another embodiment, provided is a method of generating a contextual segmentation challenge for an automated agent, the method including: obtaining at least one ad element; obtaining a test element; integrating the ad element and the test element to provide a composite image; applying one or more one noise characteristics, at least one noise characteristic including at least a first visual property and a second visual to the ad element and the test element of the composite image; and generating a plurality of views by transitioning between the first visual property and the second visual property, the views presenting an animated contextual segmentation challenge.

In yet another embodiment, provided is a system for performing the method of generating a contextual segmentation challenge for an automated agent, the system including: a receiver structured and arranged with an input device for permitting at least one ad element to be obtained and at least one test element to be received; an initializer structured and arranged to initialize each ad element and each test element with a first visual property and a second visual property, the initializer further structured and arranged to integrate the ad element and the test element to provide a composite image; a transitioner structured and arranged to transition between the first visual property and the second visual property of the ad element and the test element; and a view generator structured and arranged to generate a plurality of views of the composite image as the ad element and test element are transitioned between their respective first and second visual properties.

Further still, in yet another embodiment, provided is a method of generating a contextual segmentation challenge for an automated agent, the method including: receiving at least one data point regarding an apparent user; obtaining at least one ad element based at least in part upon at least one data point; obtaining a test element; integrating the ad element and the test element to provide a composite image; applying one or more one noise characteristics, at least one noise characteristic including a first visual property and a second visual to the ad element and the test element of the composite image; generating a plurality of views by transitioning between the first visual property and the second visual property, the views presenting an animated contextual segmentation challenge; and recording at least one behavior of the apparent user proximate to the presentation of the animated contextual segmentation challenge.

### BRIEF DESCRIPTION OF THE DRAWINGS

At least one method and system for generating a contextual segmentation challenge that poses an identification challenge will be described, by way of example in the detailed description below with particular reference to the accompanying drawings in which like numerals refer to like elements, and:

FIG. 1 illustrates a high level block diagram of a system for generating a contextual segmentation challenge for an automated agent in accordance with at least one embodiment;

FIG. 2 is a high level flow diagram for a method for generating a contextual segmentation challenge for an automated agent in accordance with at least one embodiment;

FIG. 3 illustrates the application of a noise characteristic, e.g., a first visual property and a second visual property to the composite image of at least one ad element and at least one test element in accordance with at least one embodiment;

FIG. 4 is a refined flow diagram of the transition of the composite image in accordance with at least one embodiment;

FIG. 5 illustrates the combining of transitions as views to provide the animation of the contextual segmentation challenge in accordance with at least one embodiment;

FIG. 6 illustrates an alternative combination of transitions as views to provide the animation of the contextual segmentation challenge in accordance with at least one embodiment;

FIG. 7 is a refined flow diagram of the application of a pixel grid to initialize the composite image of at least one ad element and at least one test element in accordance with at least one embodiment;

FIG. 8 illustrates the application of a pixel grid to the composite image of at least one ad element and at least one test element and the exemplary transition from the first visual property to the second visual property in accordance with at least one embodiment;

FIG. 9 illustrates yet another example of the combining of transitions as views, each having an additional noise characteristic, to provide the animation of the contextual segmentation challenge in accordance with at least one embodiment;

FIG. 10 illustrates yet still another example of the combining of transitions as views, each having an additional noise characteristic, to provide the animation of the contextual segmentation challenge in accordance with at least one embodiment;

FIG. 11 Presents a conceptual summary of the generating of a contextual segmentation challenge for an automated agent in accordance with at least one embodiment; and

FIG. 12 is a block diagram of a computer system in accordance with at least one embodiment.

### DETAILED DESCRIPTION

Before proceeding with the detailed description, it is to be appreciated that the present teaching is by way of example only, not by limitation. The concepts herein are not limited to use or application with a specific system or method for generating a contextual segmentation challenge. Thus although the instrumentalities described herein are for the convenience of explanation shown and described with respect to exemplary embodiments, it will be understood and appreciated that the principles herein may be applied equally in other types of systems and methods involving the generation of a contextual segmentation challenge.

The present disclosure advances the art by providing, in at least one embodiment, a method for generating a contextual segmentation challenge for an automated agent. Moreover, in at least one embodiment a system and method are provided to generate a challenge based on the combination of an advertising element and a test element as a composite image understandable to a human user while being frustrating to an automated bot. Applicant's co-pending application Ser. No. 12/196,389 filed on Aug. 22, 2008 and entitled “Method and System for Generating a Symbol Identification Challenge” is incorporated herein by reference.

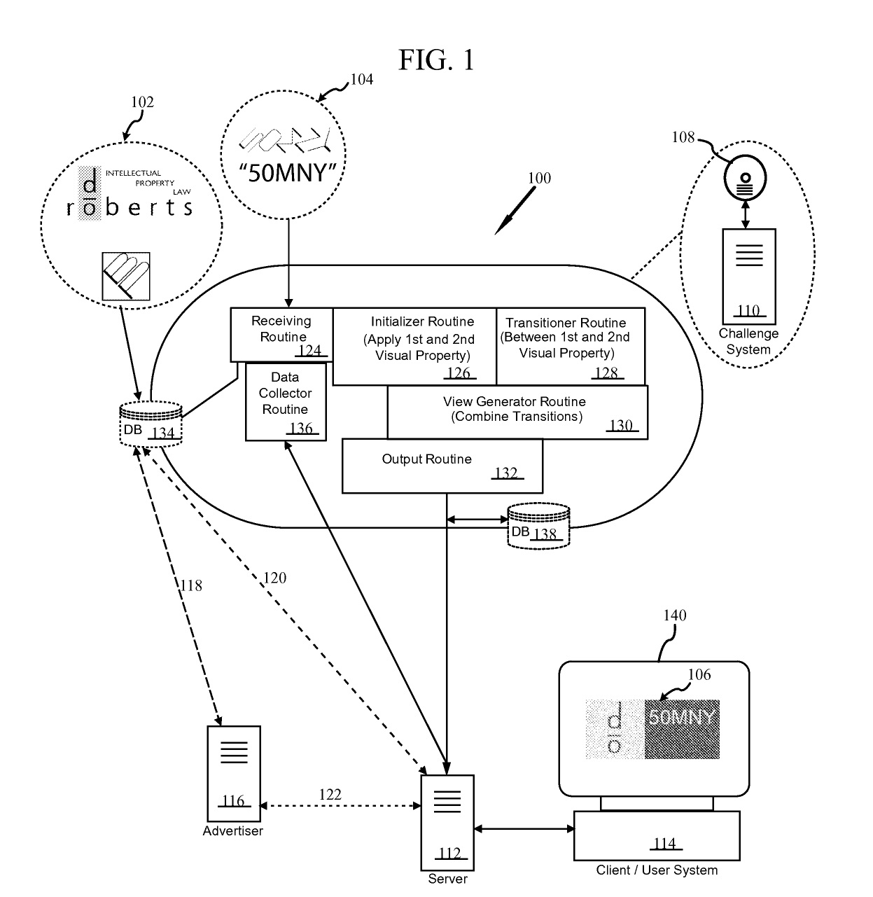

FIG. 1 is a high level block diagram of a system for generating a contextual segmentation challenge (“SFCSC”) 100 for an automated agent. As is further described in detail below, stated generally for at least one in at least one embodiment SFCSC 100 obtains at least one ad element and one test element, of which illustrated ad elements 102 and a test element 104 are exemplary. The ad element 102 and the test element 104 are combined to provide a composite image. At least one noise characteristic is added to the composite image and the composite image is then animated as a contextual segmentation challenge 106. Further, in at least one embodiment the ad element 102 and the test element 104 are discreet such that the test element 104 can not be determined from the ad element 102.

SFCSC 100 is shown to include a receiver, an initializer, a transitioner and a view generator. In varying embodiments, SFCSC 100 may also include a database, or be coupled to an existing database. With respect to FIG. 1, SFCSC 100 is conceptually illustrated in the context of an embodiment for a computer program. Such a computer program can be provided upon a non-transitory computer readable media, such as an optical disc 108 to a computer 110. SFCSC 100 may be employed on a computer 110 having typical components such as a processor, memory, storage devices and input and output devices. During operation, the SFCSC 100 may be maintained in active memory for enhanced speed and efficiency. In addition, SFCSC 100 may also be operated within a computer network and may utilize distributed resources.

In at least one embodiment, the SFCSC 100 system is provided as a dedicated system to provide contextual segmentation challenges for a plurality of server systems, of which server 112 is exemplary. In at least one alternative embodiment, SFCSC 100 is incorporated as a part of the server 112.

Server 112 is a system that a user/client system, hereinafter client 114, is accessing, such as a webserver, VPN server, network file server, mail system, or other system. The client 114 may desire further access to resources provided by server 112, active information or passive information from the server 112 or otherwise be in a condition to benefit from the presentation of a contextual segmentation challenge as provided by SFCSC 100 so as to benefit from the security of Human Only Perceptible (HOP) and/or a Human Interactive Proof (HIP) forms of data presentation and confirmation. Likewise server 112 may be guarding access to sensitive internal information and have contractual relationships with advertisers where payments are in some way tied to verifiable responses to advertisements, or otherwise be in a condition to benefit from the presentation of a contextual segmentation challenge as provided by SFCSC 100.

For the sake of example and discussion, it is presumed that server 112 is a webserver. This server 112 may provide it's own ad content, receive ad content from a remote advertiser 116, or rely on SFCSC 100 to provide the ad content. Moreover, the ad element 102 provided in the contextual segmentation challenge 106 may originate from a variety of different sources as indicated by dotted lines 118, 120, and 122.

As is further explained below, the ad element 102 obtained may be conditioned upon one or more criteria, such as for example the server data, client data, user data and or combinations thereof. The test element 104 provided in the contextual segmentation challenge 106 may also be provided by another system, such as for example one operating to provide passwords, login IDs, promotional codes, or other information. The test element 104 may also be an element that was previously provided by a human user of SFCSC 100, the client 114 or other system. In varying embodiments, the test element 104 may also be conditioned upon one or more criteria, such as for example the server data, client data, user data and or combinations thereof.

As shown in FIG. 1, SFCSC 100 includes a receiving routine 124, an initializer routine 126, a transitioner routine 128, view generator routine 130 and an output routine 132. SFCSC 100 may also contain a database 134 or be coupled to an existing database, from which at least the ad element 102 may be stored and retrieved. Moreover, in at least one embodiment, database 134 is an integral part of SFCSC 100. In at least one alternative embodiment, database 134 is maintained by the advertiser 116 or server 112 as suggested by dotted lines 118 and 120 respectively.

The receiving routine 124 is operable to obtain at least one ad element 102 and at least one test element 104. Although the following examples make use of one or two ad elements 102 and a single test element 104, it is understood and appreciated that in varying embodiments SFCSC 100 will incorporate a plurality of ad elements 102 with a test element 104, a plurality of test elements 102 with an ad element 102, and combinations thereof.

In at least one embodiment the receiving routine 124 is augmented by a data collector routine 136. The data collector routine is operable to receive at least one data point to be used in the selection of the ad element. Moreover, in at least one embodiment the data point(s) consist of server data, client data, user data and or combinations thereof. More specifically, the data point(s) may be metadata, browser history from the client 114, cookie data from the client 114, the Internet Protocol (IP) address of the client 114 and/or the IP address history, tracking codes, time of day, client site history, data regarding the user's activities and interactions with the client site, and or combinations thereof. In short, in at least one embodiment SFCSC 100 utilizes at least one data point to selectively obtain ad element 102 for use in establishing the contextual segmentation challenge 106.

In the accompanying figures for purposes of example, the test element 104 is shown to be “50MNY” and the ad element 102 is shown to be an ad graphic ad “Bot-Proof” in a first instance and an ad graphic for “d roberts Intellectual Property Law” in a second instance. In varying embodiments the ad element and the test element may be provided as one or more alphanumeric characters, a non-alphanumeric character such as an icon, arrow, logo, figure and or combinations thereof. In at least one embodiment the ad element 102 and test element 104 may be provided as or with symbol identification, such as for example ASCII representation code. Alternative forms of symbol data may include, but are not limited to BMP (Windows Bitmap®), GIF (CompuServe Graphical Image Format), PNG (Portable Network Graphics), SVG (Scalable vector Graphics), VRML (Virtual Reality Markup Language), WMF (Windows MetaFile®), AVI (Audio Visual Interleave), MOV (QuickTime movie), SWF (Shockwave Flash), DirectX, OpenGL, Java, Windows®, MacOS®, Linux, PDF (Portable Document Format), JPEG (Joint Photographic Experts Group, MPEG (Moving Picture Expert Group) or the like.

As is further discussed below and illustrated in the accompanying figures, SFCSC 100 operates to combine the ad element 102 and the test element 104 into a composite image that is then animated as a contextual segmentation challenge 106. To further enhance the segmentation challenge aspect of the composite image and the animation, in at least one embodiment, the test element 104 is rendered with at least one characteristic of the ad element 102. For example these characteristics may be color, font style, font size, orientation, character spacing, and or combinations thereof.

The initializer routine 126 is operable in at least one embodiment to apply at least one variable noise characteristic to the ad element 102 and the test element 104. The one or more noise characteristics increase the segmentation challenge as noise increases the overall complexity of the image. In at least one embodiment at least one variable noise characteristic is a first visual property and a second visual property.

More specifically, in at least one embodiment the initializer routine 126 applies a first visual property and a second visual property to the ad element 102 and the test element 104. The initializer routine 126 is further structured and arranged to integrate the ad element 102 and the test element 104 as a composite image. In at least one embodiment the ad element 102 and the test element 104 are integrated as the composite image before the first and second visual properties are applied. In at least one alternative embodiment the first and second visual properties are individually applied to the ad element 102 and the test element 104 before they are combined as the composite image.

In at least one embodiment these properties are contrast values. It is further understood and appreciated that contrast values permit the difference between things, e.g., the foreground and background, to be distinguished and appreciated. In many instances the contrast values are applied to one or more colors. In at least one alternative embodiment these properties are colors. Further still, in at least one embodiment the visual properties applied to the ad element 102 are the same visual properties applied to the test element 104. In yet still another alternative embodiment the visual properties applied to the ad element 102 are inverted when applied to the test element 104. Further, in at least one embodiment, the variation, e.g., limits, of the first and second visual properties applied to the ad element 102 and the test element 104 are determined at least in part by characteristics of the ad element, e.g., color, hue, shade, tint or other visual property.

The transitioner routine 128 is operable to transition the composite image between the first and second visual properties of the ad element 102 and test element 104 collectively or individually. In other words the transitioner routine 128 advantageously adjusts and/or changes the one or more noise characteristics of the ad element 102 and test element 104 collectively or individually. The generate views routine 130 is operable to generate a plurality of views of the composite image as the ad element 102 and the test element 104 are transitioned between their respective first and second visual properties.

The output routine 132 is operable to output the generated views of the contextual segmentation challenge 106. In at least one embodiment this output is directed to a long term storage device such as database 138. The animated contextual segmentation challenge 106 may in varying embodiments be directed to the server 112 and/or to the display 140 of a user.

With respect to the above routines and illustration of FIG. 1, it is understood and appreciated that in at least one embodiment hardware elements can be substituted for each routine. Moreover, in at least one embodiment, SFCSC 100 comprises a receiver 24, an initializer 126, a transitioner 128, view generator 130, an outputer 132, an optional data collector 136 and databases 134 and 138.

It is understood and appreciated that the contextual segmentation challenge 106 is not simply an animation of the ad element or rather an traditional advertising video clip, with a challenge based on some element of the advertisement as presented. The animated composite image of the ad element 102 and the test element 104, incorporating at least one noise characteristic presents a contextual segmentation challenge that requires recognition of the noise elements/characteristics, and their removal as well as the ability to recognize and distinguish the ad element 102 from the test element 104—a task heightened by the context of the test element being discrete from the context of the ad element. In other words, the contextual segmentation challenge 106 entices a human user to pay attention—key for the advertiser. However, because of the use of an ad, and the general predisposition of human users to recognize ads quickly, from the standpoint of a human user the contextual segmentation challenge 106 is not so complex as to be annoying or unduly challenging. Rather the contextual segmentation challenge 106 may often be perceived as fun.

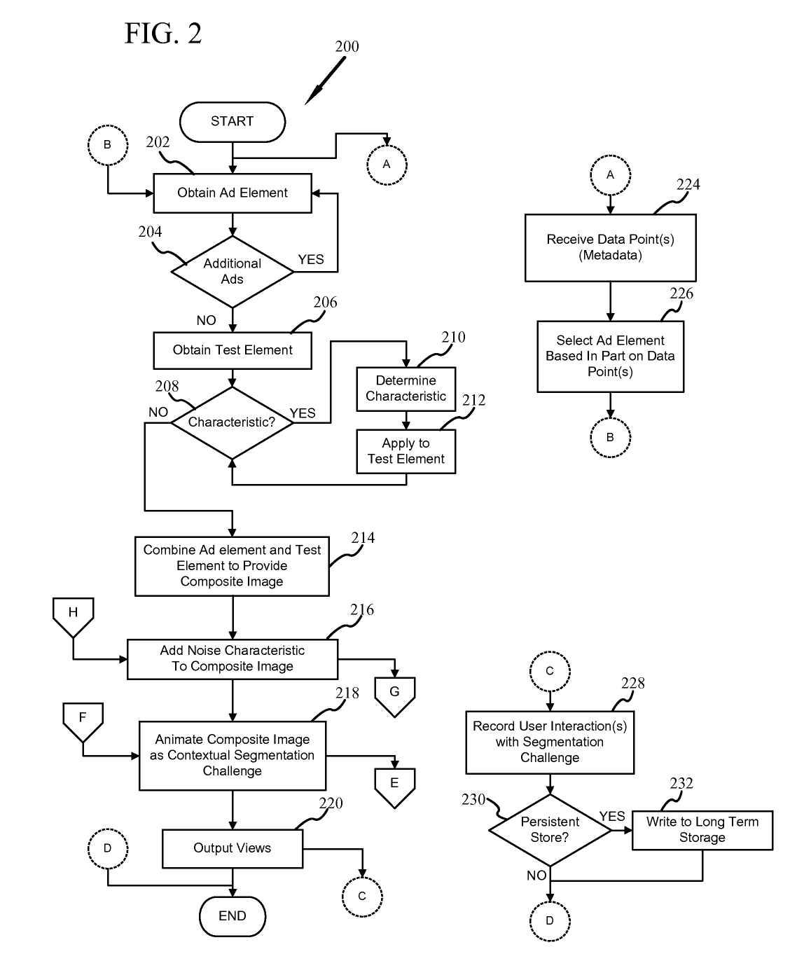

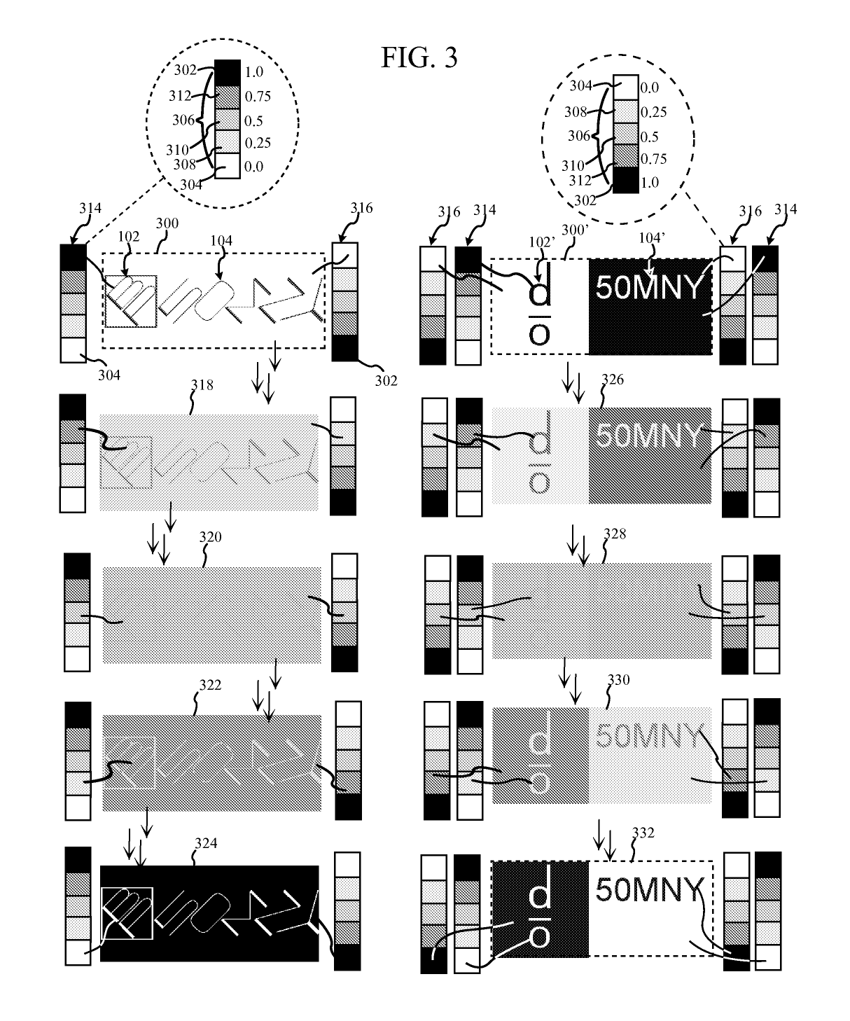

FIG. 2 in connection with FIGS. 3-10 provides a high level flow diagram with conceptual illustrations depicting a method 200 for generating a contextual segmentation challenge in accordance with at least one embodiment. It will be appreciated that the described method need not be performed in the order in which it is herein described, but that this description is merely exemplary of one method of generating a contextual segmentation challenge.

To summarize, in at least one embodiment, the method 200 includes obtaining at least one ad element and at least one test element. The ad element and the test element are integrated to provide a composite image. At least one noise characteristic is added to the composite image and the composite image is animated as a plurality of views as a contextual segmentation challenge. The animation as the contextual segmentation challenge is then output to a display, a requesting server, a database or other storage device, and or combinations thereof.

Moreover, in at least one embodiment, the method 200 commences with obtaining an ad element, e.g., ad element 102, as shown in block 202. As noted above, different embodiments permit a variety of formats for the ad element 102. Additional ad elements may also be provided, decision 204.

As with the at least one ad element, a test element is also obtained, block 206. The test element 104 likewise may be provided in a variety of formats depending on varying embodiments. With respect to both the ad element(s) 102 and the test element 104, in varying embodiments each element may be provided with associated data. This data may be removed and stored for later use and/or reference.

As noted above, in at least one embodiment the test element 104 is rendered with at least one characteristic of the ad element 102. In one embodiment, the test element 104 may be provided to SFCSC 100 with one or more ad element related characteristics already manifested. In an alternative embodiment, data associated with the ad element 102 is used to demine the one or more ad related characteristics that are to be applied to the test element 104. In yet another embodiment, the ad element 102 is analyzed, such as for example by optical character recognition or other text recognition system to determine one or more appropriate characteristics.

Moreover, in accordance with at least one embodiment the method determines if a characteristic of the ad element 102 is to be applied to the test element 104, decision 208. In the affirmative, a characteristic is determined and/or selected, block 210, and applied to the test element 104, block 212. For additional characteristics this process is repeated, decision 208 again.

Continuing, the ad element 102 and the test element 104 are combined to provide a composite image, block 214. With respect to the composite image, in at least one embodiment the ad element 102 and the test element 104 are adjacent to each other. Moreover, in at least one embodiment the ad element 102 and the test element 104 are disposed in contact with one another. In at least one alternative embodiment the ad element 102 and the test element 104 are at least partially imposed upon each other.

At least one noise characteristic is then added to the composite image, block 216. In at least one embodiment the noise characteristic is provided as a varying first visual property and a varying second visual property. In at least one embodiment, the first visual property is a foreground property and the second visual property is a background property. Further still, in at least one embodiment the visual properties are that of color. In an alternative embodiment, the visual properties are that of contrast. In yet an alternative embodiment, the visual properties are that of luminance. In yet still another embodiment, the visual properties are that of transparency. Still further, in yet another embodiment the foreground and background properties are varying combinations of color, luminance, contrast and transparency.

Of course it is to be understood and appreciated that the ad element 102 may be provided in a condition where it has from the outset preexisting first and second visual properties such as a foreground and background color. In at least one embodiment the preexisting visual properties, e.g., foreground and background color, determine the range of visual properties for the composite image.

As noted above, in at least one embodiment the ad element 102 and the test element 104 are integrated as the composite image before the first and second visual properties are applied. In at least one alternative embodiment the first and second visual properties are individually applied to the ad element 102 and the test element 104 before they are combined as the composite image. FIG. 3 provides a conceptual illustration of at least two different embodiments for how the visual properties are applied and subsequently transitioned.

Specifically, FIG. 3 provides a conceptual illustration of the ad element 102 and the test element 104 combined as a composite image 300, and ad element 102′ and the test element 104′ combined as a composite image 300′. As shown, the test element 104 is shown with common characteristics of the ad element 102, e.g., slanted character orientation and stylized font. Similarly, the test element 104′ is shown with common characteristics of the ad element 102′, e.g., normal orientation and a more traditional font.

The composite images 300 and 300′ each have a foreground color 302 (black) and a background color 304 (white). It is understood and appreciated that luminance values can also provide the visualization of black and white, however for purposes of illustration and discussion, the colors of black and white, and the range therebetween have been adopted. It is also understood and appreciated, that colors other than black and white may be employed.

With respect to FIG. 3, it is also understood and appreciated that the foreground color 302 and background color 304 define a range 306. For an embodiment wherein the foreground and background property is that of illumination, the range is a luminance range. For an embodiment employing transparency, generally the foreground and background also have at least a color or luminance value in addition to a transparency value ranging from about entirely transparent to about entirely opaque.

It is understood and appreciated that the first and second visual properties are in one instance the same for ad element and the test element, such as with composite image 300. In yet an alternative embodiment it is understood that the first and second visual properties are different for different elements, such as with the composite image 300′. For at least one embodiment with respect to the composite image 300, the application of the first and second visual properties may be described as being applied globally to the composite image. For at least one alternative embodiment with respect to the composite image 300′, the application of the first and second visual properties may be described as being distinctly applied to the ad element 102′ and the test element 104′.

Returning to FIG. 2, the composite image is then animated to provide the contextual segmentation challenge, or more specifically an animated contextual segmentation challenge. In accordance with method 200, this is achieved by generating a plurality of views by transitioning through the range defined by the first and second visual properties, and or between the ad element and the test element, block 218. The plurality of views are then output, block 220, such as to a storage device, e.g., hard drive 138, the requesting server 112, a display 140 or the like, and combinations thereof.

With respect to the overall basic flow of method 200, it will be appreciated that optional steps indicated by the dotted lines to dotted references A and B may be used to provide a targeted ad element 102 in at least one embodiment. More specifically as shown in optional block 224 at least one data point is received prior to obtaining the ad element 102. The data point(s) consist of server data, client data, user data and/or combinations thereof. More specifically, in at lest one embodiment the data point(s) is selected from metadata, browser history from the client 114, cookie data from the client 114, the Internet Protocol (IP) address of the client 114 and/or the IP address history, tracking codes, time of day, client site history, data regarding the user's activities and interactions with the client site, and or combinations thereof. In at least one embodiment, the data point(s) are also used for the selection of an appropriate test element 104.

The data point(s) may be used directly, or used to access a repository of user data so as to potentially identify or at least classify the user or type of user for whom a contextual segmentation challenge is desired. Moreover, a targeted ad element 102 is selected based in part on the data point(s), block 226.

For example, data points indicating that the user had recently been on one or more search sites seeking information about advertising and HOP security systems could be used to select one or more ad elements 102 regarding BotProof. Similarly, data points for a different user having recently been searching for information on patents and trademarks could be used to select an one or more ad elements 102 regarding the D Roberts Intellectual Property Law. Data points from yet another user could indicate use of the client system very early in the morning and thus be used to help select an ad element relating to coffee and or breakfast foods.

In yet another case, data points from a user may identify that user as a good past customer, the ad element 102 being selected for a preferred item of past purchase. For this user, the test element 104 may also be selected at least in part based on the data point, such as to offer the user a coupon code for free shipping, discount on purchase, or an access code for premium items not commonly available. Of course, even with such general commonality of purpose, it is understood and appreciated that a shipping code, discount code, or other communiqué for the user's benefit can't be determined directly from the ad element 102 itself.

In addition to optionally targeting the ad element 102, method 200 may also optionally track the behavior of the user in response to the contextual segmentation challenge, as indicated by optional steps indicated by the dotted lines to dotted references C and D. More specifically, as shown in optional block 228, a record is made of the users interaction(s) with the segmentation challenge. For example these actions may include recognizing the hover location or movement of a mouse or other on screen indicator, the users actions to select icons, hyperlinks or other interactive elements, the users response time in submitting the correct test response indicative of having perceived the test element 104, the users interaction with the ad element 102 or other ad related material available to the user (such as to click on the ad element 102 or other ad material and activate an embedded hyperlink), and or combinations thereof. Moreover, in addition to being integrated as a contextual segmentation challenge, in varying embodiments the ad element 102 and or the test element 104 may also be user interactive elements, the user's interactions being recordable data.

This tracked information may be immediately used for the rendering of additional material and or options for presentation to the user. In at least one embodiment a decision is made as to whether or not the data regarding the users interactions should be maintained as a historical record, decision 230. For example, some advertisers may desire to track historical activities whereas other advertisers may not. If the decision is made to store the users interactions, at least some part of the relevant data is written to long term storage, block 232. In at least one embodiment, this long term storage may include providing a cookie or other file back to the client 114 which may be used in a subsequent contextual segmentation challenge as provided by SFCSC 100.

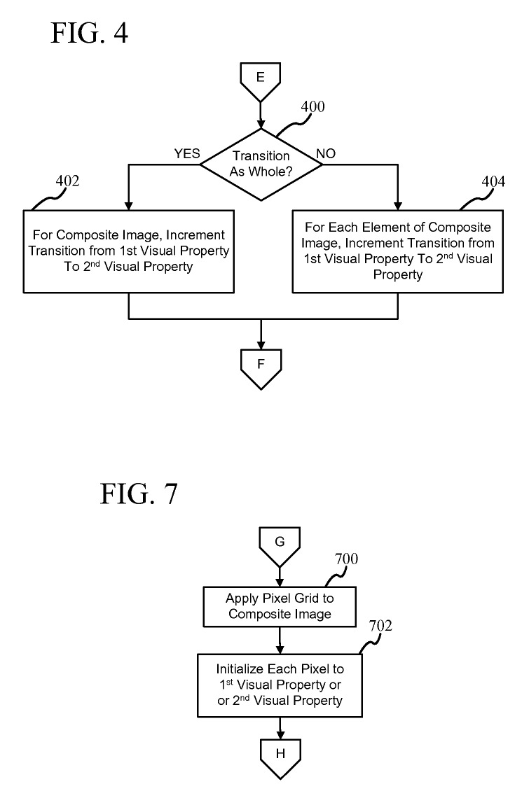

FIG. 4 provides a refined flow diagram for the action of generating the plurality of views. At least two options for transition are presented by the examples shown in FIG. 3. With the defined range 306 of visual properties for the composite image, e.g., composite image 300 and composite image 300′, the composite image may be transitioned as a whole or the ad element 102 and test element 104 transitioned individually, decision 400 leading to block 402 for collective transition and block 404 for individual transition.

In at least one embodiment the transition from the first visual property to the second visual property (e.g., foreground to background) is a cyclical process, though in varying embodiments the cycle may or may not have the same period from one cycle to the next. In at least one alternative embodiment from the first visual property to the second visual property (e.g., foreground to background) has no defined cycle, such that each transition from the first visual property to the second visual property occurs in a different and unpredictable manner.

In varying embodiments the transition of the composite image, or each element comprising the composite image may be described as a stream of data, which may be stored for later processing or contemporaneously combined with the streams of other symbols. As is understood by those skilled in the arts, a stream may be advantageous in processing for only portions of the stream are required at any given time. Moreover, the stream may be maintained in storage memory that is read periodically to obtain the next elements of the stream for subsequent processing. The transition of the composite image, or each element comprising the composite image may also be described as the elements of an audiovisual product, such as for example a Group of Pictures, understood and appreciated to be a group of successive pictures within a coded video stream as is typically recorded to an optical storage device such as a disc, i.e., a CD, DVD, BluRay or other physically identifiable and tangible optical data storage device.

With respect to the exemplary range 306, shown in FIG. 3, if the initial black color 302 is taken to be represented by the value of “1.0” and the initial white color 302 is taken to be the value of “0.0” then the intervening colors 308, 310 and 312 are respectively represented by the values at 0.25 increments therebetween, i.e., “0.25”—308, “0.5”—310 and “0.75”—312. These values are shown in the first visual property indicator 314 and second visual property indicator 316.

Transition of the composite image as a whole is exemplified by the illustrated transition of composite image 300 between the first visual property, e.g., the foreground color 302, and the second visual property, e.g., the background color 304. More specifically composite image 318 results from incrementing the foreground towards the background one step while incrementing the background towards the foreground one step.

Incrementing the foreground and the background yet again results in composite image 320. Further incrementing the foreground and the background yet again results in composite image 322 and a final increment of the foreground and the background results in composite image 324. In at least one embodiment, each composite image 300, 318, 320, 322 and 324 is a view. Although the transition as shown involves four iterations, it is understood and appreciated that the actual number of iterations is application dependent. Indeed in certain embodiments the transition may be across a continuum, effectively rendering the identification of individually distinct views as moot. More specifically, each view is simply selected based on an interval of time or other event as dictated by the application embodiment.

Transition of each element, e.g., the ad element 102 and the test element 104, of the composite image is exemplified by the illustrated transition of composite image 300′. For the heightened sake of example the first visual property, e.g., the foreground color 302, and the second visual property, e.g., the background color 304, are inverted as applied to the test element 104′. In other words the initial first visual property of the ad element 102′ is about the same as the initial second visual property of the test element 104′ and the initial second visual property of the ad element 102′ is about the same as the initial first visual property of the test element 104′.

Composite image 326 results from incrementing the background towards the foreground one step for the ad element 102′ while incrementing the background towards the foreground one step for the test element 104′. Incrementing the respective foreground and background properties yet again successively provides composite images 328, 330 and 330 as shown.

As with the collective transition of composite image 300, although the transition of composite image 300′ as shown involves four iterations, it is understood and appreciated that the actual number of iterations is application dependent. Indeed in certain embodiments the transition may be across a continuum, effectively rendering the identification of individually distinct views as moot.

It is further understood and appreciated that as the ad element 102′ and the test element 104′ are each transitioned independently, in at least one embodiment these transitions occur simultaneously. In another embodiment these transitions occur separately. In yet another embodiment the duration of the transitions is about the same for the ad element 102′ and the test element 104′. Further still in yet another embodiment the duration of the transition for the ad element 102′ is different from the duration of the transition of the test element 104′.

In addition, wherein the transition of the ad element 102 and the test element 104 are indeed independent, it will be further understood and appreciated that the complexity of the transition of the test element 104 may be increased without affect to the ad element 102. In other words, the test element may be combined with other elements, such as a noise symbol and transitioned in such a way that a complete view, e.g., a key view, of the test element 104 is not provided at any point during the animation. Moreover, in at least one embodiment the test element 102 is treated as a base symbol and combined with at least one noise symbol for transition as set forth and described in applicant's co-pending application Ser. No. 12/196,389 filed on Aug. 22, 2008 and entitled “Method and System for Generating a Symbol Identification Challenge.”

With respect to both the transition of composite image 300 and composite image 300′, it is understood and appreciated that for each there is a midpoint in transition where the first visual property, e.g., the foreground color, is about equal to the second visual property, e.g., the background color. This is exampled by composite images 320 and 328. Moreover the views of 320 and 328 are midpoints of transition wherein the visual properties are about equal. In at least one embodiment the cycle of transition is measured from midpoint to midpoint. In varying embodiments the midpoint of transition may also serve as a reference point to switch between multiple ad elements and or test elements.

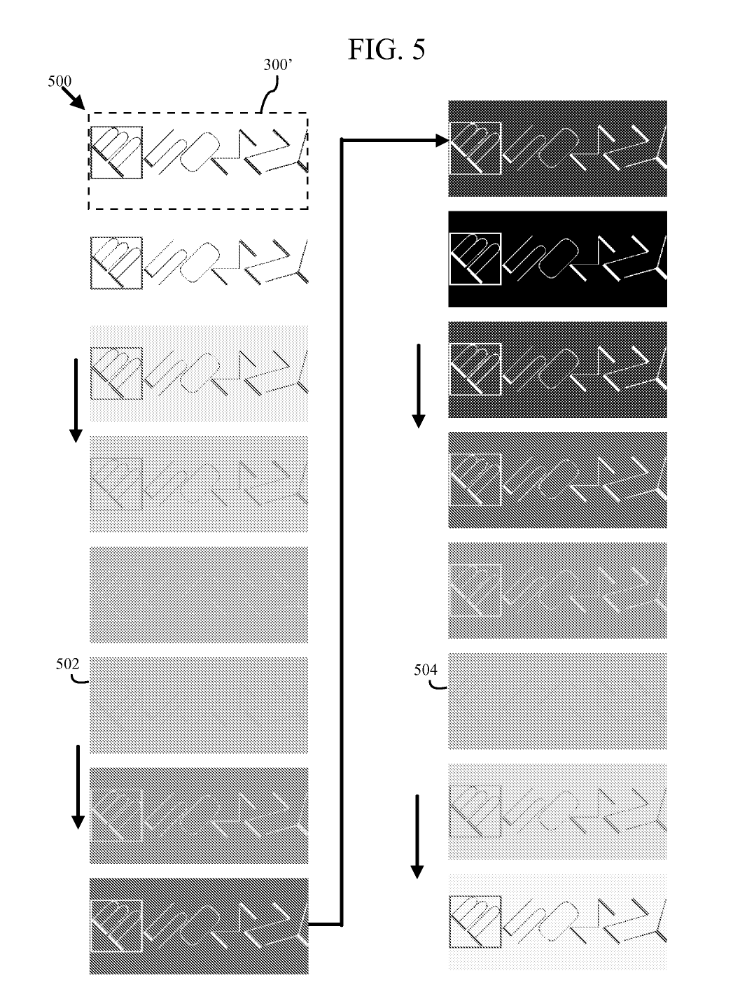

FIG. 5 illustrates a further example of a complete cycle 500 of transition for the composite image 300. The first midpoint 502 occurs with the transition of the first visual property represented as the foreground color to the second visual property represented as the background color. In others words, the composite image 300 initially appearing as black lettering on a white background is transitioning to white lettering on a black background. The second midpoint 504 represents the transition once again where the first visual property and the second visual property are again about equal, such that the composite image 300 transitions from white lettering on a black background to black lettering on a white background.

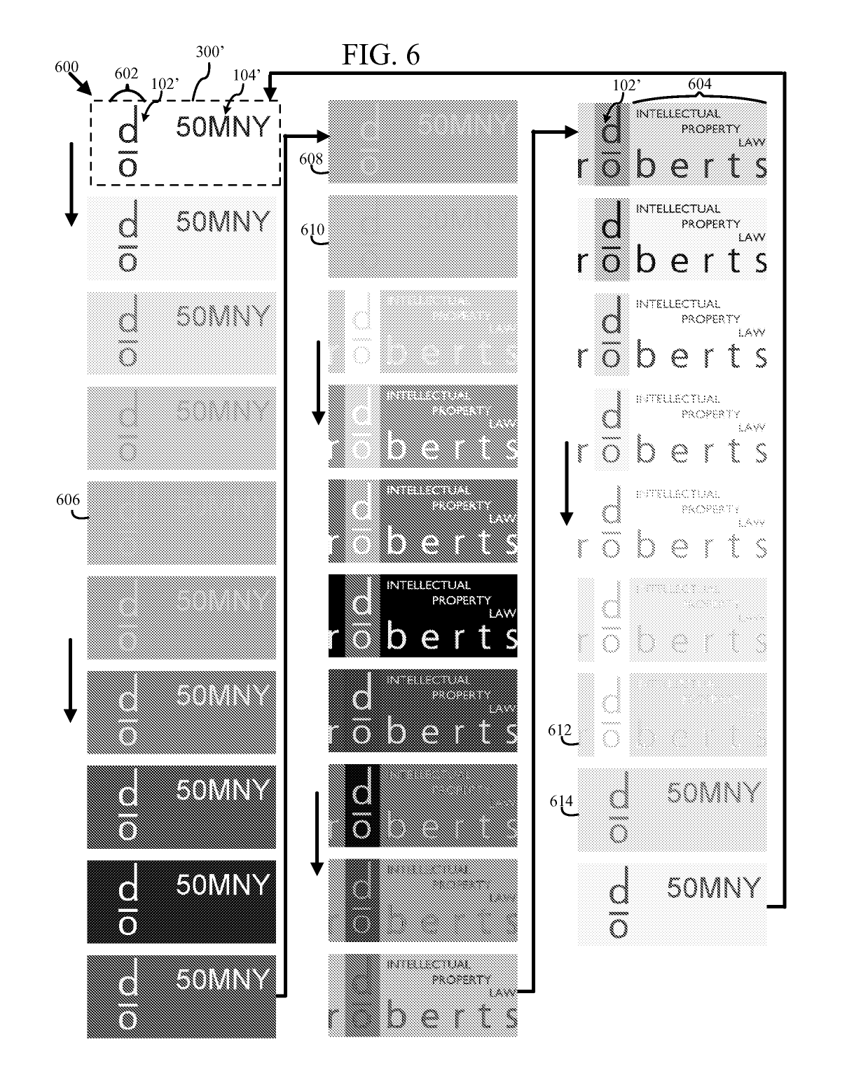

FIG. 6 illustrates an example of the complete cycle 600 of the transition for the composite image 300′. In addition, FIG. 6 illustrates that an ad element 102, or at least a first portion 602 of an ad element 102 is substantially continuously visible as part of the animated image throughout the majority of cycle 600. With respect to FIG. 6 and the illustrated cycle 600 it is further noted that at least a second portion 604 of the ad element is substantially obscured during the animation cycle 600. In other words, in at least one embodiment during the cycle 600 a first portion 602 of an ad element 102 is substantially visible for at least about 51% of the cycle 600, while a second portion 602 of an ad element 102 is substantially visible for less than about 51% of the cycle 600. In yet another embodiment, an ad element 102 or at least a first portion 602 of an ad element 102 is substantially visible for at least about 70% of the cycle 600, while a second portion 602 of an ad element 102, or other ad elements 102 are substantially obscured for at least about 31% of the cycle 600.

With respect to the illustrative example of cycle 600, a midpoint of transition, such as midpoint 606 may be included in the transition from foreground to background, e.g., black on white to white on black, or omitted. More specifically a midpoint has been omitted between composite image view 608 and composite image view 610 which also illustrates a transition of the test element 104′ to be replaced with a more complete representation of the ad element 102′. Likewise a midpoint transition is omitted from the transition of the composite image view 612 of the ad element 102′ to the composite image view 614 wherein the test element 104 is again imposed upon at least a part of the ad element 102′.

Moreover, because the contextual segmentation challenge is presented as an animated sequence that combines ad elements with test elements, it is understood and appreciated that in varying embodiment according to varying sequences of animation the percentage of a single view being composed of an ad element may be significantly more than the percentage being composed of by a test element. Indeed in at least one embodiment, during the animation of the contextual segmentation challenge a portion of the animation may be about entirely an ad element. Further, in at least one embodiment, throughout the entire animation of the contextual segmentation challenge at least one ad element is substantially always visible.

With respect to FIG. 6 it is may be appreciated that in at least one embodiment the first portion 602 of the ad element 102 may be achieved by using multiple ad elements—the complete advertisement and the apparent masked portion of the advertisement. Moreover, it is understood and appreciated that the first portion 602 of the ad element 102 is intended to be a sufficient portion to convey understanding and/or recognition of the ad.

In yet further embodiments, additional related ad elements may also be transitioned through—thus maintaining the common advertisement theme and further raising the complexity of the segmentation challenge. It is understood and appreciated that in varying embodiments this same process of maintaining a common portion is applied to the test element. Specifically, a first portion of the test element remains substantially continuously visible as part of the animated composite image, at least a second portion of the test element being about entirely obscured by the noise characteristic and/or the ad element during the animation.

More specifically the examples illustrate in the accompanying figures do not provide a contextual basis upon which the ad element 102 may be separated from the test element 104. Indeed the abilities of the human user of SFCSC 100 are required and when applied will advantageously recognize and appropriately segment the ad element(s) 102 from the test element 104.

It is further understood and appreciated that in at least one embodiment the context of the test element is discrete from the context of the ad element. In other words the test element 104 cannot be derived form the ad element 102. As a result, as shown in FIG. 6 the continuity of a portion of the ad element and/or the introduction of variations of the ad element 102 enhance the advertising nature of the contextual segmentation challenge but does not otherwise diminish the security of the challenge as an automated agent still has no basis to distinguish ad elements from test elements, let alone properly segment one or more ad elements from the test element.

With respect to the first visual property and the second visual property as applied to the composite image 300 collectively or discretely to the ad element 102 and the test element 104 of the composite image, it is appreciated that the properties may be achieved in a variety of ways as appropriate for varying embodiments. For example, in at least one embodiment the ad element 102 and the test element 104 are processed as vectors upon a background area. The vector elements of the ad element 102 and the test element 104 and their respective or collective background area are each individually addressable and therefore each may be assigned a different visual property, e.g., a first visual property to be transitioned to a second visual property, such as a foreground color and a background color.

In at least one alternative embodiment the ad element 102 and the test element 104 of the composite image are pixilated. In FIG. 2, block 216 indicating the addition of at least one noise characteristic to the composite image has off page references leading to FIG. 7, which further illustrates the flow diagram for such a pixilation in accordance with at least one embodiment.

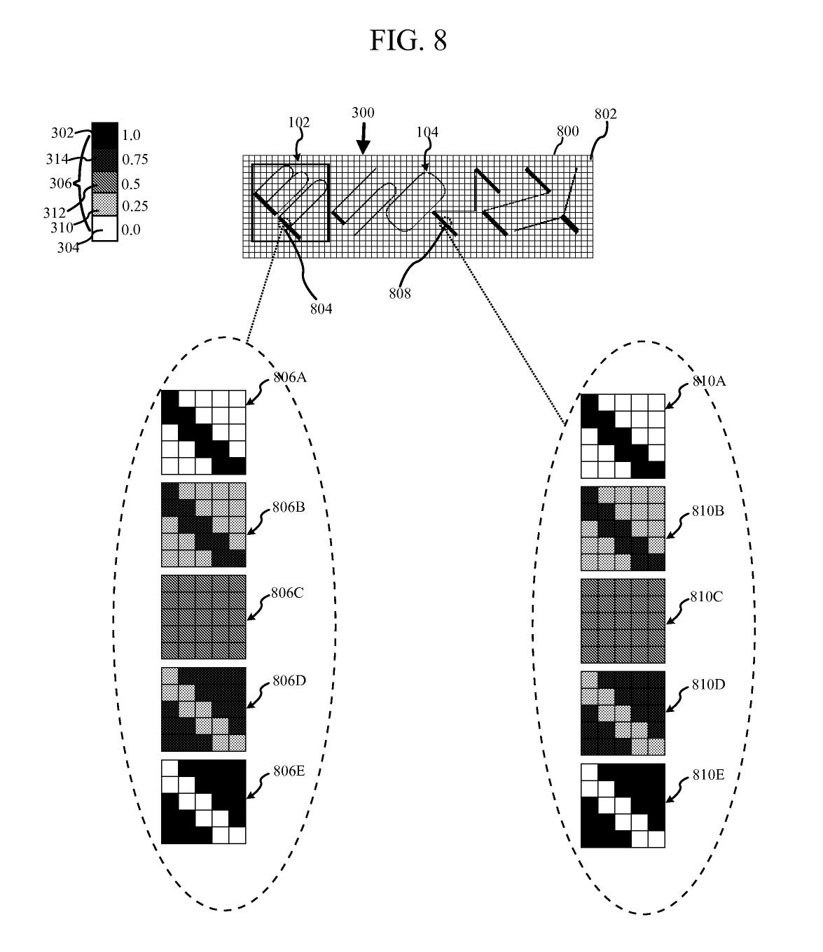

FIG. 7 may be further understood and appreciated in connection with FIG. 8. In at least one embodiment the addition of at least one noise characteristic is facilitated by applying a pixel grid 800 to the composite image 300, block 700. It is understood and appreciated that the pixel grid 800 defines common pixel locations, of which pixel 802 is exemplary, for all subsequent composite images 300, or more specifically the views of each composite image during transition. It maybe assumed that the same pixel grid 800 is used for composite images 300 undergoing transition.

As used herein a pixel is understood and appreciated to be a single point in a raster image. In other words the pixel is the smallest addressable screen element, the smallest unit of the image or picture that can be controlled. The size of each pixel is therefore application dependent and can vary from one embodiment to another. With respect to the example pixel grid 800 being illustrated as being eighteen (18) pixels by sixty (60) pixels, it is understood and appreciated that pixel grid 800 is not shown to scale.

With the pixel grid 800 imposed and the pixel locations so defined, each pixel is initialized to either a first visual property or a second visual property, block 702. As discussed above, the initial first visual property may be a foreground property and the initial second visual property may be a background property, the first and second property thereby establishing a range of the visual property. In at least one embodiment the visual property is color. In an alternative embodiment the visual property is contrast. In yet another alternative embodiment the visual property is luminance. Further still in another embodiment, the visual properties are varying combinations of color, luminance, contrast and transparency.

For ease of discussion and illustration, the visual property of color and the range 306 as between black 302 and white 304 is again repeated from FIG. 3. Dotted circle 804 is intended to identify the an exemplary five by five pixels set 806 for the ad element 102 and dotted circle 808 is intended to identify an exemplary five by five pixel set 810 for the test element 104. It is further understood and appreciated that as pixel grid 800 is a constant, if additional ad elements or test elements are intended to replace or impose upon other elements during transition, the pixel locations defined by the pixel grid 800 remain constant for all ad elements or test elements as aligned to the pixel grid 800.

Set 806A conceptually illustrates a portion of the “B” from the ad element 102, specifically a portion of the stylized “P”. Set 806A conceptually illustrates a portion of the M from the test element 104, specifically a portion of the stylized “M”. Sets 806B, 810B, 806C, 810C, 806D, 810D and 806E, 810E each respectively show the exemplary 0.25 incremental change of each pixel to transition from the initial condition shown in 806A, 810A to the inverted condition show in 806E, 810E.

As is visually apparent, the transitions of these two elements are identical due to the similarity in the enlarged sections between the ad element 102 and the test element 104. As such, even on the pixel level there is no clear indication to provide guidance for segregation of the ad element 102 from the test element 104.

It should also be noted that sets 806C and 808C each conceptually illustrate midpoints in transition. As substantially all the pixels are about equal in visual property in at least one embodiment the midpoint of transition serves as a convenient location from which to transition from one ad element or test element to yet another ad element or test element. Such a transition process is more fully described in the earlier cited and incorporated co-pending application Ser. No. 12/196,389.

In addition to the application of a first visual property and a second visual property as a noise characteristic, the use of pixel grid 800 also permits the introduction of additional noise characteristics. For example in at least one embodiment, in addition to being transitioned along the range 306 as defined by the first visual property and the second visual property, each pixel is also subject to a random determination to be at one extreme or the other, on or off, or to some other characteristic. More specifically, in at least one embodiment each pixel is also subject to the random possibility of being set to appear as the second visual property, e.g., the background color. This noise characteristic may be described as adding snow or speckling to the composite image.

As the addition of noise is determined randomly for each pixel during each transition, and may be set to last for no more than one transition before the pixel returns to it's intended value within the range 306, the snow characteristic will vary substantially from one transition to the next.

Moreover, in at least one embodiment the addition of a snow noise characteristic is provided by . . . (fill in with description when provided).

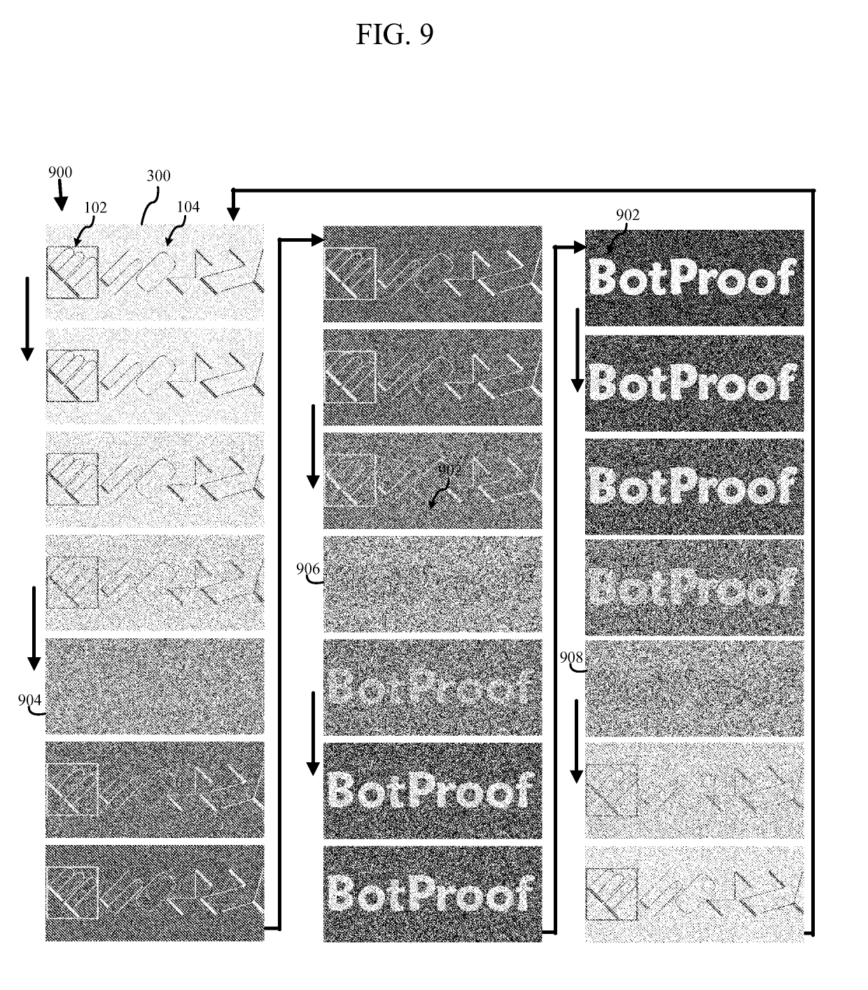

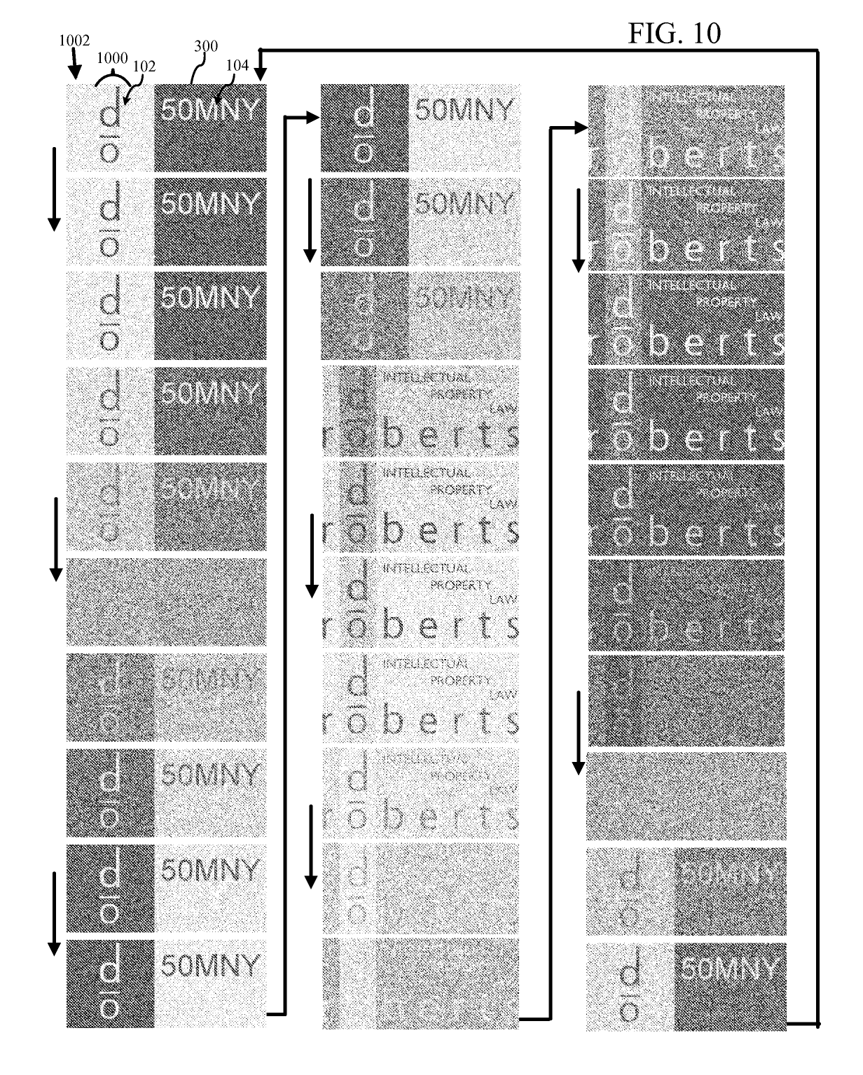

FIGS. 9 and 10 present examples of such added snow. In FIG. 9, an additional ad element 900, e.g., the stylized logo BotProof, has been added. Specifically, in the first transition midpoint 904, the ad element 102 and test element 104 transition from black on white to white on black. However, in the second transition midpoint the composite image 300 transitions to the new ad element 902. In the third transition midpoint 908 the composite image 300 transitions back to the initial ad element 102 and test element 104. This cycle increase the segmentation challenge as again the context of the test element is discrete from the context of either ad element 102, 902.

FIG. 10 employs initially inverting the first and second visual properties of the ad element 102 as applied to the test element 104, incorporates the additional noise characteristic of snow, and substantially maintains a first portion 1000 of the ad element 102 as generally continuously visible as part of the animated image throughout the majority of cycle 1002.

With respect to the examples shown in FIGS. 3, 5, 6 and 8-10 it is clear that the ad element 102 and test element 104 are transitioning incrementally. In at least one alternative embodiment the transitioning of the visual property is performed incrementally in accordance with a pattern. Examples of varying patterns for at least pixel transition are set forth in and more fully described in the earlier cited and incorporated co-pending application Ser. No. 12/196,389.

With respect to FIGS. 3, 5, 6 and 8-10 it is understood and appreciated that each and every part of the displayed view transitions through the entire range of the applied visual property. A common action employed in attempting to crack CAPTCHA representations is often to superimpose multiple images, if not all the images upon one another with the expectation that the embedded information will be more clearly revealed. SFCSC 100 and/or method 200 is advantageously impervious to such action as a compilation of the generated views, if not all of the views will simply result in a composite image wherein all areas exhibit the extreme visual property applied (e.g., black color, extreme illumination, extreme contrast, or other property).

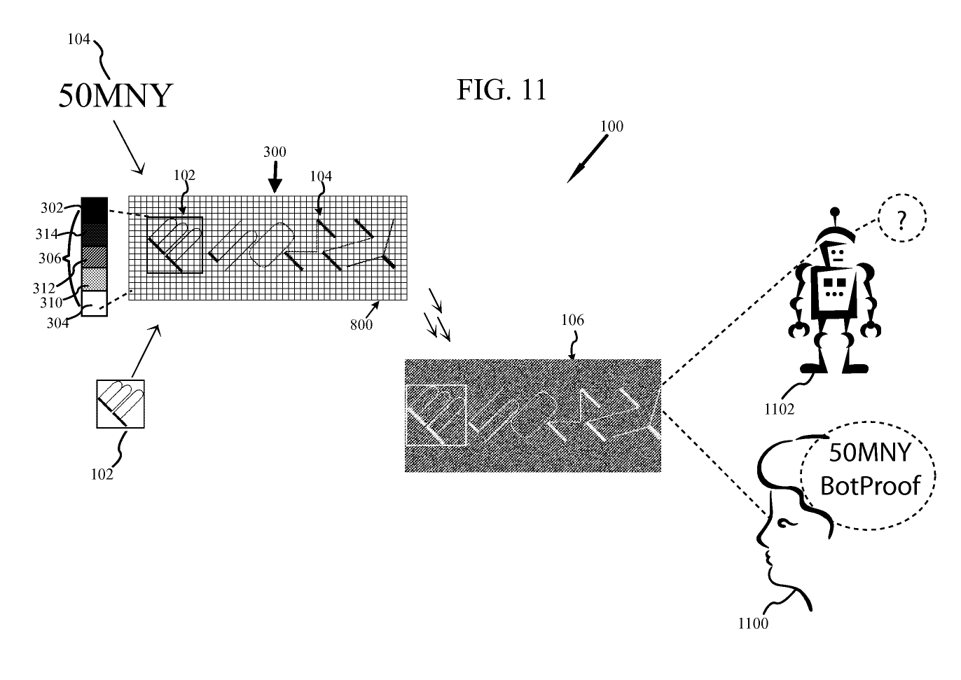

FIG. 11 conceptually summarizes the above discussion. More specifically, an ad element 102 and a test element 104 are obtained and combined into a composite image 300. At least one noise characteristic is applied, specifically a first visual property and a second visual property are applied to the composite image. As discussed above, in at least one embodiment the visual property is that of color, the foreground and background colors providing a range 306 for transition.

The composite image is then transitioned through the range 306 to provide a plurality of views. Moreover, in at least one embodiment the composite image 300 is pixilated by a grid 800, each pixel is then varied throughout the range 306. In the example of FIG. 11 an additional noise characteristic, described above as snow, is also added and present in each transition of the composite image 300.

The transitions through the range 306, provide a plurality of views which taken collectively provide an animation of the composite image as the contextual segmentation challenge 106. The resulting contextual segmentation challenge is perceived by a human 1100 and understood to be both the advertisement for BotProof as inferred from the logo, e.g., ad element 102, and the test data 50MNY. If the same animated views as the contextual segmentation challenge are perceived by an automated agent 1102, the complexity of the transition of each element and/or the composite image view of the combined transitions is confounding. In other words the resulting views are human only perceptible (HOP), and pose an advantageous challenge to an automated agent 1102.

With respect to the above discussion, and specifically the example set forth in FIG. 11, it is to be understood and appreciated that SFCSC 100 and/or method 200 are advantageously capable of providing a contextual segmentation challenge as a HOP. SFCSC 100 and/or method 200 can of course be further augmented by incorporating a proof option wherein the user must respond and supply the determined test element 104. Such a test may be appropriate where SFCSC 100 and/or method 200 are employed to safeguard access to systems and information, however the advantageous ability to provide such a robust HOP permits adoption of SFCSC 100 and/or method 200 in situations where no response is need, required or perhaps practical—but there remains a significant desire to insure that the data conveyed by the contextual segmentation challenge is indeed perceived by a human user and not an automated agent.

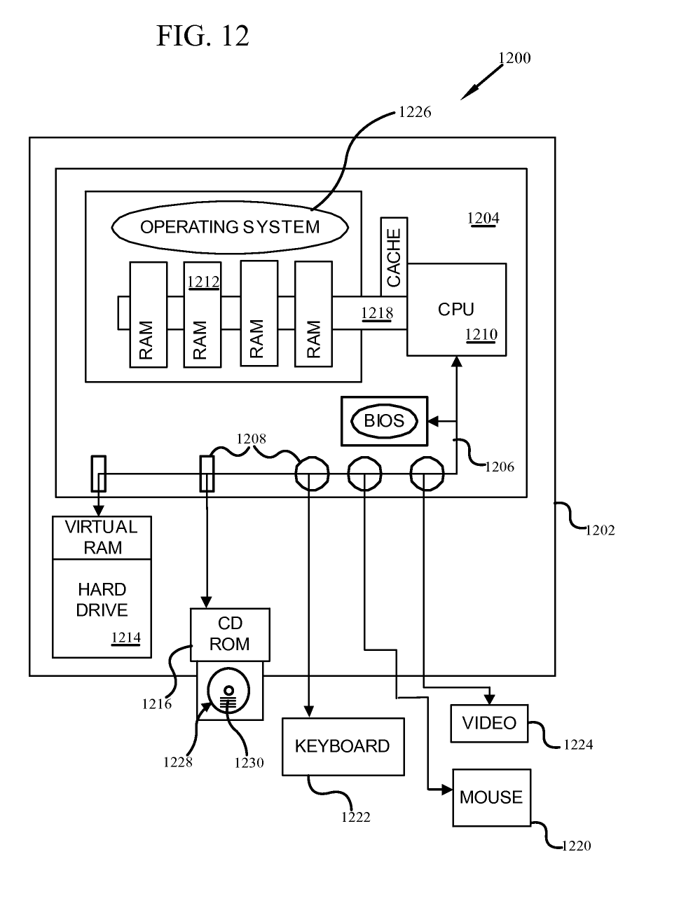

With respect to the above description of SFCSC 100 and method 200, it is understood and appreciated that the method may be rendered in a variety of different forms of code and instruction as may be preferred for different computer systems and environments. To expand upon the initial suggestion of a computer implementation suggested above, FIG. 12 is a high level block diagram of an exemplary computer system 1200. Computer system 1200 has a case 1202, enclosing a main board 1204. The main board has a system bus 1206, connection ports 1208, a processing unit, such as Central Processing Unit (CPU) 1210 and a memory storage device, such as main memory 1212, hard drive 1214 and CD/DVD ROM drive 1216.

Memory bus 1218 couples main memory 1212 to CPU 1210. A system bus 1206 couples hard drive 1214, CD/DVD ROM drive 1216 and connection ports 1208 to CPU 1210. Multiple input devices may be provided, such as for example a mouse 1220 and keyboard 1222. Multiple output devices may also be provided, such as for example a video monitor 1224 and a printer (not shown).

Computer system 1200 may be a commercially available system, such as a desktop workstation unit provided by IBM, Dell Computers, Gateway, Apple, Sun Micro Systems, or other computer system provider. Computer system 1200 may also be a networked computer system, wherein memory storage components such as hard drive 1214, additional CPUs 1210 and output devices such as printers are provided by physically separate computer systems commonly connected together in the network. Those skilled in the art will understand and appreciate that physical composition of components and component interconnections comprising computer system 1200, and select a computer system 1200 suitable for the schedules to be established and maintained.

When computer system 1200 is activated, preferably an operating system 1226 will load into main memory 1212 as part of the boot strap startup sequence and ready the computer system 1200 for operation. At the simplest level, and in the most general sense, the tasks of an operating system fall into specific categories—process management, device management (including application and user interface management) and memory management.

In such a computer system 1200, the CPU 1210 is operable to perform one or more of the methods of representative symbol generation described above. Those skilled in the art will understand that a computer-readable medium 1228 on which is a computer program 1230 for generating representation symbols may be provided to the computer system 1200. The form of the medium 1228 and language of the program 1230 are understood to be appropriate for computer system 1200. Utilizing the memory stores, such as for example one or more hard drives 1214 and main system memory 1212, the operable CPU 1202 will read the instructions provided by the computer program 1230 and operate to perform the scheduling system 100 as described above.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A method of generating a contextual segmentation challenge for an automated agent, the method comprising:
obtaining at least one ad element;
obtaining a test element;
combining the ad element and the test element to provide a composite image;
adding at least one noise characteristic to the composite image; and
animating the composite image as a plurality of views as a contextual segmentation challenge.

2. The method of claim 1, wherein adding at least one noise characteristic and animating the composite image comprises:
applying a first visual property and a second visual to the composite image; and
generating the plurality of views by transitioning between the first visual property and the second visual property.

3. The method of claim 2, wherein the transitioning between the first visual property and the second visual property of the ad element and the test element occurs simultaneously.

4. The method of claim 2, wherein the transitioning between the first visual property and the second visual property of the ad element and the test element occurs independently.

5. The method of claim 4, wherein an additional noise characteristic is applied to the test element.

6. The method of claim 1, wherein the context of the test element is discrete from the context of the ad element.

7. The method of claim 1, wherein the composite image presents the ad element and the test element adjacent to one another.

8. The method of claim 1, wherein the composite image presents the ad element and the test element at least partially imposed upon each other, the animation transitioning between the ad element and the test element.

9. The method of claim 1, further including receiving at least one data point prior to obtaining the ad element, the ad element selected at least in part based upon the at least one data point.

10. The method of claim 9, wherein the at least one data point is selected from the group consisting of server data, client data, user data and or combinations thereof.

11. The method of claim 9, the test element selected at least in part based upon the at least one data point.

12. The method of claim 1, further including tracking at least one user behavior during presentation of the animated composite image to a user.

13. The method of claim 1, wherein the test element is rendered with at least one characteristic of the ad element.

14. The method of claim 13, wherein the at least one characteristic is selected from the group consisting of font style, font size, character spacing, and or combinations thereof.

15. The method of claim 1, wherein at least a first portion of the ad element remains continuously visible as part of the animated composite image, at least a second portion of the ad element being about entirely obscured by the noise characteristic as part of the animated composite image.

16. The method of claim 1, wherein the method is stored on a non-transitory computer-readable medium as a computer program which, when executed by a computer will perform the steps of generating a contextual segmentation challenge.

17. A method of generating a contextual segmentation challenge for an automated agent, the method comprising:
obtaining at least one ad element;
obtaining a test element;
integrating the ad element and the test element to provide a composite image;
applying one or more one noise characteristics, at least one noise characteristic including at least a first visual property and a second visual to the ad element and the test element of the composite image; and
generating a plurality of views by transitioning between the first visual property and the second visual property, the views presenting an animated contextual segmentation challenge.

18. The method of claim 17, wherein the context of the test element is discrete from the context of the ad element.

19. The method of claim 17, wherein transitioning between the first visual property and the second visual property of the ad element and the test element occurs simultaneously.

20. The method of claim 17, wherein transitioning between the first visual property and the second visual property of the ad element and the test element occurs independently.

21. The method of claim 17, wherein the first visual property and the second visual property are established by parameters of the ad element.

22. The method of claim 17, wherein in a first instance the composite image presents the ad element and the test element adjacent to one another, and in a second instance the composite image presents the ad element and the test element at least partially imposed upon each other, the animation transitioning between the ad element and the test element.

23. The method of claim 17, wherein the first visual property of the ad element is about equal to the second visual property of the test element and the second visual property of the ad element is about equal to the first visual property of the test element.

24. The method of claim 17, further including receiving at least one data point prior to obtaining the ad element, the ad element selected at least in part based upon the at least one data point.

25. The method of claim 24, wherein the at least one data point is selected from the group consisting of server data, client data, user data and or combinations thereof.

26. The method of claim 17, further including tracking at least one user behavior during presentation of the animated composite image to a user.

27. The method of claim 17, further including imposing a grid upon composite image, the grid defining pixel locations for the ad element and the test element.

28. A system for performing the method of claim 11, the system comprising:
a receiver structured and arranged with an input device for permitting at least one ad element to be obtained and at least one test element to be received;
an initializer structured and arranged to initialize each ad element and each test element with a first visual property and a second visual property, the initializer further structured and arranged to integrate the ad element and the test element to provide a composite image;
a transitioner structured and arranged to transition between the first visual property and the second visual property of the ad element and the test element; and
a view generator structured and arranged to generate a plurality of views of the composite image as the ad element and test element are transitioned between their respective first and second visual properties.

29. The system of claim 29, further including a data collector routine structured and arranged to collect at least one data point prior to the selection of the ad element, the data point used at least in part by the receiver to selectively obtain the ad element.

30. The method of claim 17, wherein the method is stored on a non-transitory computer-readable medium as a computer program which, when executed by a computer will perform the steps of generating a contextual segmentation challenge.

31. A method of generating a contextual segmentation challenge for an automated agent, the method comprising:
receiving at least one data point regarding an apparent user;
obtaining at least one ad element based at least in part upon at least one data point;
obtaining a test element;
integrating the ad element and the test element to provide a composite image;
applying one or more one noise characteristics, at least one noise characteristic including a first visual property and a second visual to the ad element and the test element of the composite image;
generating a plurality of views by transitioning between the first visual property and the second visual property, the views presenting an animated contextual segmentation challenge; and
recording at least one behavior of the apparent user proximate to the presentation of the animated contextual segmentation challenge.

32. The method of claim 31, wherein the at least one data point is selected from the group consisting of server data, client data, user data and or combinations thereof.

33. The method of claim 31, wherein the context of the test element is discrete from the context of the ad element.

34. The method of claim 31, wherein in a first instance the transitioning between the first visual property and the second visual property of the ad element and the test element occur simultaneously, and in a second instance the transitioning between the first visual property and the second visual property of the ad element and the test element occurs independently.

35. The method of claim 31, the test element selected at least in part based upon the at least one data point.

36. The method of claim 31, wherein the method is stored on a non-transitory computer-readable medium as a computer program which, when executed by a computer will perform the steps of generating a contextual segmentation challenge.
